(19) United States
(12) Patent Application Publication
(10) Pub. No.: US 2007/0294113 A1
(43) Pub. Date: Dec. 20, 2007

(54) Method for evaluating correlations between structured and normalized information on genetic variations between humans and their personal clinical patient data from electronic medical patient records

(75) Inventor: Phillip David Settimi, Chicago, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/601,358

(22) Filed: Nov. 17, 2006

Related U.S. Application Data
(60) Provisional application No. 60/813,397, filed on Jun. 14, 2006.

(51) Int. Cl. G06F 19/00

(52) U.S. Cl. 705/3

(57) ABSTRACT

Various embodiments of the presently described invention provide a method for evaluating correlations between genetic variations and clinical information. The method includes normalizing one or more of genotypic data and clinical data associated with each of a plurality of patients in a population of patients, receiving one or more clinical conditions from a user, selecting a subset of patients from the population based on the clinical conditions, and determining one or more correlations between at least one of the clinical conditions and one or more of the genotypic and clinical data for the patient subset.

### RELATED APPLICATIONS

This application claims the benefit of U.S. Provisional Application No. 60/813,397 (the “'397 application”), filed Jun. 14, 2006, entitled “Method For Evaluating Correlations Between Structured And Normalized Information On Genetic Variations Between Humans And Their Personal Clinical Patient Data From Electronic Medical Patient Records.” The '397 application is incorporated by reference herein in its entirety.

### BACKGROUND OF THE INVENTION

The present invention generally relates to search and analysis of electronic medical record data. More particularly, the present invention relates to evaluating correlations between genetic and clinical information included in electronic medical records.

Hospitals typically utilize computer systems to manage the various departments within a hospital and data about each patient is collected by a variety of computer systems. For example, a patient may be admitted to the hospital for a Transthoracic Echo (“TTE”). Information about the patient (for example, demographics and insurance) could be obtained by the hospital information system (“HIS”) and stored on a patient record. This information could then be passed to the cardiology department system (commonly known as the cardio vascular information system, or “CVIS”), for example. Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (for example, an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be sent to a data repository for public data mining. Medication instructions, such as documentation and/or prescriptions, as well as laboratory results and vital signs, may also be generated electronically and saved in a data repository.

Today, medical device manufacturers and drug companies face an ever-growing challenge in collecting clinical data on the real-life utilization of their products. As patient medical reports are becoming computerized, the ability to obtain real-life utilization data becomes easier. Further, the data is easier to combine and analyze (for example, mine) for greater amounts of useful information.

As medical technology becomes more sophisticated, clinical analysis may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, it would be highly desirable for clinical information to be organized and standardized.

Data warehousing methods have been used to aggregate, clean, stage, report and analyze patient information derived from medical claims billing and electronic medical records (“EMR”). Patient data may be extracted from multiple EMR databases located at patient care provider (“PCP”) sites in geographically dispersed locations, then transported and stored in a centrally located data warehouse. The central data warehouse may be a source of information for population-based profile reports of physician productivity, preventative care, disease-management statistics and research on clinical outcomes.

Current efforts to evaluate correlations between genotypic and phenotypic data in the human population are performed in relatively small and controlled clinical studies using paper-based medical records. Such efforts consume considerable amounts of time and resources. In addition, paper-based efforts are unlikely to identify subtle associations between genetic variability and phenotypic susceptibility. For example, these efforts are unlikely to uncover subtle associations or correlations between genetic variability (for example, a propensity for a particular single nucleotide polymorphism (“SNP”) or combination of SNPs) and actual phenotypic expressions of traits associated with the genetic variability.

Current efforts to obtain such correlations and associations are also limited by the different syntax used in different clinical trials. In order to fully evaluate and understand such correlations and associations, it is often beneficial to examine larger amounts of data, for example from multiple clinical trials. However, genetic and clinical information may be recorded using different terms, or syntax, in different clinical trials. For example, a clinical condition or event such as a heart attack may be expressed or recorded as “heart attack” in one trial, as “myocardial infarction” in another trial, as “MI” in another trial, an “acute MI” in another trial, and an “AMI” in yet another trial. However, if the clinical data from two or more of these trials were combined (along with corresponding genetic information) in order to evaluate correlations between one or more SNPs and the potential for a heart attack, the different syntax would inhibit, if not prevent, an accurate evaluation of any such correlations. In other words, the lack of a controlled medical vocabulary makes it unlikely to demonstrate conclusive evidence of such associations or correlations due to the variability of clinical language chosen to describe patient expression of clinical conditions or disease.

Therefore, there is a need for improved methods to evaluate correlations between genetic variations among patients and personal clinical patient data derived from electronic medical records in a variety of different trials.

### BRIEF DESCRIPTION OF THE INVENTION

Various embodiments of the presently described invention provide a method for evaluating correlations between genetic variations and clinical information. The method includes normalizing one or more of genotypic data and clinical data associated with each of a plurality of patients in a population of patients, receiving one or more clinical conditions from a user, selecting a subset of patients from the population based on the clinical conditions, and determining one or more correlations between at least one of the clinical conditions and one or more of the genotypic and clinical data for the patient subset.

Various embodiments of the presently described invention also provide a computer-readable storage medium comprising a set of instructions for a computer. The instructions include a data normalization routine, a patient selection routine and a correlation routine. The data normalization routine is configured to normalize one or more of genotypic data and clinical data associated with each of a plurality of patients in a population of patients. The patient selection routine is configured to select a subset of patients from the population based on one or more clinical conditions input by a user. The correlation routine is configured to determine one or more correlations between at least one of the clinical conditions and one or more of the genotypic and clinical data for the subset of patients.

Various embodiments of the presently described invention also provide a method for determining correlations between genetic data and medical data. The method includes receiving genotypic data and clinical data associated with each of a plurality of patients from a plurality of sources, where two or more of the sources uses different terms to report the genotypic and/or clinical data, normalizing the genotypic and/or clinical data, selecting one or more patients from the plurality of patients based on one or more parameters, and determining a correlation between one or more of the parameters and at least one of the genotypic and clinical data associated with two or more of the selected patients.

### BRIEF DESCRIPTION OF SEVERAL VIEWS OF THE DRAWINGS

FIG. 1 illustrates a schematic diagram of a system for storing EMRs in accordance with an embodiment of the presently described technology.

FIG. 2 illustrates a schematic diagram of a data warehouse architecture in accordance with an embodiment of the presently described technology.

FIG. 3 illustrates a schematic diagram of genetic and/or clinical data aggregation system in accordance with an embodiment of the presently described technology.

FIG. 4 illustrates a flowchart for a method for evaluating one or more correlations between genetic and clinical data in accordance with an embodiment of the presently described technology.

The foregoing summary, as well as the following detailed description of certain embodiments of the presently described technology, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The presently described technology provides, among other things, an improved method for combining genetic data with more traditional clinical data of a codified nature and employing these data sets to come up with, and test, various hypotheses and correlations between diseases, traits, medical conditions/problems and environmental factors, for example. The technology permits integration of a data source such as codified genetic data with a new data source such as codified clinical data obtained from a plurality of different sources. In doing so, different nomenclature used by the various sources of the clinical data can be codified so as to permit easier comparisons between the clinical and genetic data.

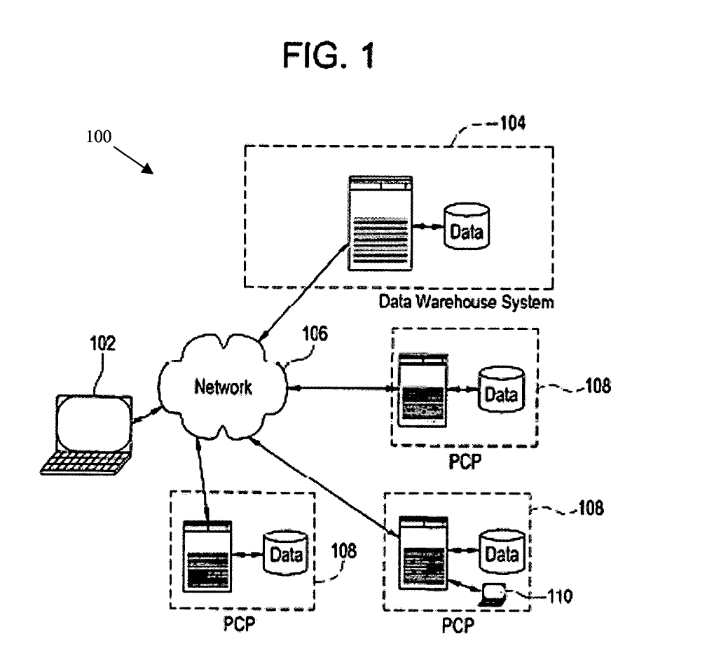

FIG. 1 illustrates a schematic diagram of a system 100 for storing EMRs in accordance with an embodiment of the presently described technology. PCP systems 108 located at various PCP sites are connected to a network 106. The PCP systems 108 send patient medical data (included in EMRs) to a data warehouse located on a data warehouse system 104. The PCP systems 108 typically include application software to perform data extraction along with one or more storage device for storing the EMRs associated with patients treated at the PCP site. In addition, the PCP systems 108 can include PCP user systems 110 to access the EMR data, to initiate the data extraction and to enter a password string to be used for encrypting a patient identifier.

The PCP user systems 110 can be directly attached to the PCP system 108 or the user systems 110 can access the PCP system 108 via the network 106. Each PCP user system 110 can be implemented using a general-purpose computer executing a computer program for carrying out the processes described herein. The PCP user systems 110 can be personal computers or host attached terminals. If the PCP user systems 110 are personal computers, the processing described herein can be shared by a PCP user system 110 and a PCP system 108 by providing an applet to the PCP user system 110.

The storage device located at the PCP system 108 can be implemented using a variety of devices for storing electronic information such as a file transfer protocol (“FTP”) server. It is understood that the storage device can be implemented using memory contained in the PCP system 108 or it can be a separate physical device. The storage device contains a variety of information including an EMR database.

In addition, the system of FIG. 1 includes one or more data warehouse user systems 102 through which an end-user can make a request to an application program on the data warehouse system 104 to access particular records stored in the data warehouse. In an example embodiment of the present invention, end-users can include PCP staff members, pharmaceutical company research team members and personnel from companies that make medical products.

The data warehouse user systems 102 can be directly connected to the data warehouse system 104 or they can be coupled to the data warehouse system 104 via the network 106. Each data warehouse user system 102 can be implemented using a general-purpose computer executing a computer program for carrying out the processes described herein. The data warehouse user systems 102 can be personal computers or host attached terminals. If the data warehouse user systems 102 are personal computers, the processing described herein may be shared by a data warehouse user system 102 and the data warehouse system 104 by providing an applet to the data warehouse user system 102.

The network 106 can be any one or more types of known networks including a local area network (“LAN”), a wide area network (“WAN”), an intranet, or a global network (for example, Internet). A data warehouse user system 102 can be coupled to the data warehouse system 104 through multiple networks (for example, intranet and Internet) so that not all data warehouse user systems 102 are required to be coupled to the data warehouse system 104 through the same network. Similarly, a PCP system 108 can be coupled to the data mining host system 104 through multiple networks (for example, intranet and Internet) so that not all PCP systems 108 are required to be coupled to the data warehouse system 104 through the same network.

One or more of the data warehouse user systems 102, the PCP systems 108 and the data warehouse system 104 can be connected to the network 106 in a wireless fashion and the network 106 may be a wireless network. In an example embodiment, the network 106 is the Internet and each data warehouse user system 102 executes a user interface application to directly connect to the data warehouse system 104. In another embodiment, a data warehouse user system 102 can execute a web browser to contact the data warehouse system 104 through the network 106. Alternatively, a data warehouse user system 102 can be implemented using a device programmed primarily for accessing the network 106 such as WebTV.

The data warehouse system 104 can be implemented using a server operating in response to a computer program stored in a storage medium accessible by the server. The data warehouse system 104 can operate as a network server (often referred to as a web server) to communicate with the data warehouse user systems 102 and the PCP systems 108. The data warehouse system 104 handles sending and receiving information to and from data warehouse user systems 102 and PCP systems 108 and can perform associated tasks. The data warehouse system 104 can also include a firewall to prevent unauthorized access to the data warehouse system 104 and enforce any limitations on authorized access. For instance, an administrator can have access to the entire system and have authority to modify portions of the system and a PCP staff member can only have access to view a subset of the data warehouse records for particular patients. In an example embodiment, the administrator has the ability to add new users, delete users and edit user privileges. The firewall can be implemented using conventional hardware and/or software as is known in the art.

The data warehouse system 104 also operates as an application server. The data warehouse system 104 executes one or more application programs to provide access to the data repository located on the data warehouse system, as well as application programs to import patient data into a staging area and then into the data warehouse. In addition, the data warehouse system 104 can also execute one or more applications to create patient cohort reports and to send the patient cohort reports to the PCP systems 108. Processing can be shared by the data warehouse user system 102 and the data warehouse system 104 by providing an application (for example, a java applet) to the data warehouse user system 102. Alternatively, the data warehouse user system 102 can include a stand-alone software application for performing a portion of the processing described herein. Similarly, processing can be shared by the PCP system 102 and the data warehouse system 104 by providing an application to the PCP system 102 and alternatively, the PCP system 102 can include a stand-alone software application for performing a portion of the processing described herein. It is understood that separate servers may be used to implement the network server functions and the application server functions. Alternatively, the network server, firewall and the application server can be implemented by a single server executing computer programs to perform the requisite functions.

The storage device located at the data warehouse system 104 can be implemented using a variety of devices for storing electronic information such as an FTP server. It is understood that the storage device can be implemented using memory contained in the data warehouse system 104 or it may be a separate physical device. The storage device contains a variety of information including a data warehouse containing patient medical data from one or more PCPs. The data warehouse system 104 can also operate as a database server and coordinate access to application data including data stored on the storage device. The data warehouse can be physically stored as a single database with access restricted based on user characteristics or it can be physically stored in a variety of databases including portions of the database on the data warehouse user systems 102 or the data warehouse system 104. In an example embodiment, the data repository is implemented using a relational database system and the database system provides different views of the data to different end-users based on end-user characteristics.

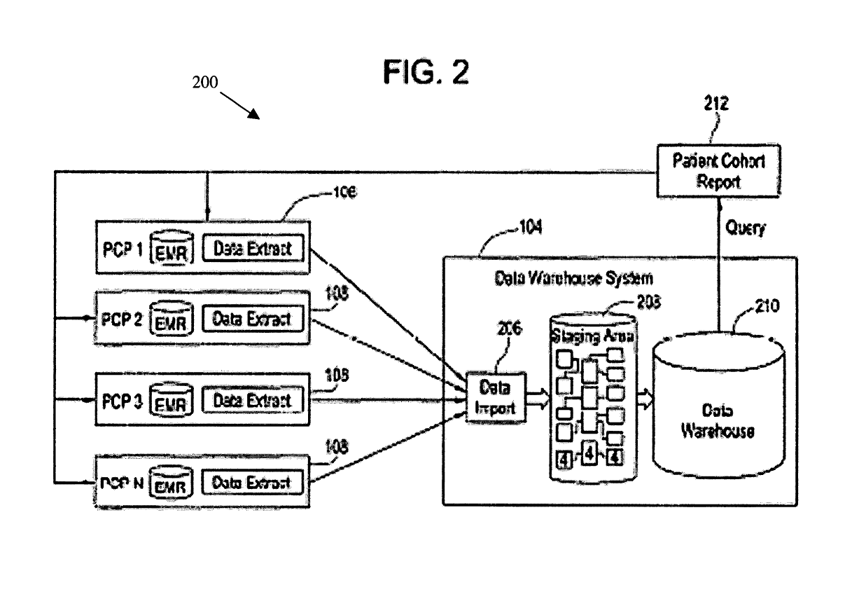

FIG. 2 illustrates a schematic diagram of a data warehouse architecture 200 in accordance with an embodiment of the presently described technology. Patient data is extracted from EMR databases located in the PCP systems 108. An EMR database record includes medical data such as: patient name and address, medications, allergies, observations, diagnoses, and health insurance information, for example. The PCP systems 108 include application software for extracting patient data from the EMR database. The data is then transported (for example, via Hypertext Transfer Protocol (“HTTP”) or Secure HTTP (“HTTPS”)) over the network 106 to the data warehouse system 104.

The data warehouse system 104 includes application software to perform a data import function 206. The data import function 206 aggregates patient data from multiple sites and then stores the data into a staging area 208. Data received from multiple PCP systems 108 is normalized, checked for validity and completeness, and either corrected or flagged as defective. Data from multiple PCP systems 108 can then be combined together into a relational database. Aggregation and staging data in the described fashion allows the data to be queried meaningfully and efficiently, either as a single entity or specific to each individual PCP site 108. The de-identified patient data is then staged into a data warehouse 210 where it is available for querying.

Patient cohort reports 212 are generated by application software located on the data warehouse system 104 and returned to the PCP systems 108 for use by the primary care providers in treating individual patients. Patient cohort reports 212 can be automatically generated by executing a canned query on a periodic basis. PCP staff members, pharmaceutical company research team members and personnel from companies that make medical products may each run patient cohort reports 212, for example. In addition, patient cohort reports 212 can be created by an end-user accessing a data warehouse user system 102 to create custom reports or to initiate the running of canned reports. Further, patient cohort reports 212 can be automatically generated in response to the application software, located on the data warehouse system 104, determining that particular combinations of data for a patient are stored in the data warehouse. An example patient cohort report 212 includes all patients with a particular disease that were treated with a particular medication. Another example patient cohort report 212 includes patients of a particular age and sex who have particular test results. For example, a patient cohort report 212 can list all women with heart disease who are taking a hormone replacement therapy drug. The patient cohort report 212 can list all the patients with records in the data warehouse 210 that fit this criteria. In an example embodiment, each PCP site receives the entire report; in another embodiment, each PCP site can receive the report only for patients that are being treated at the PCP site.

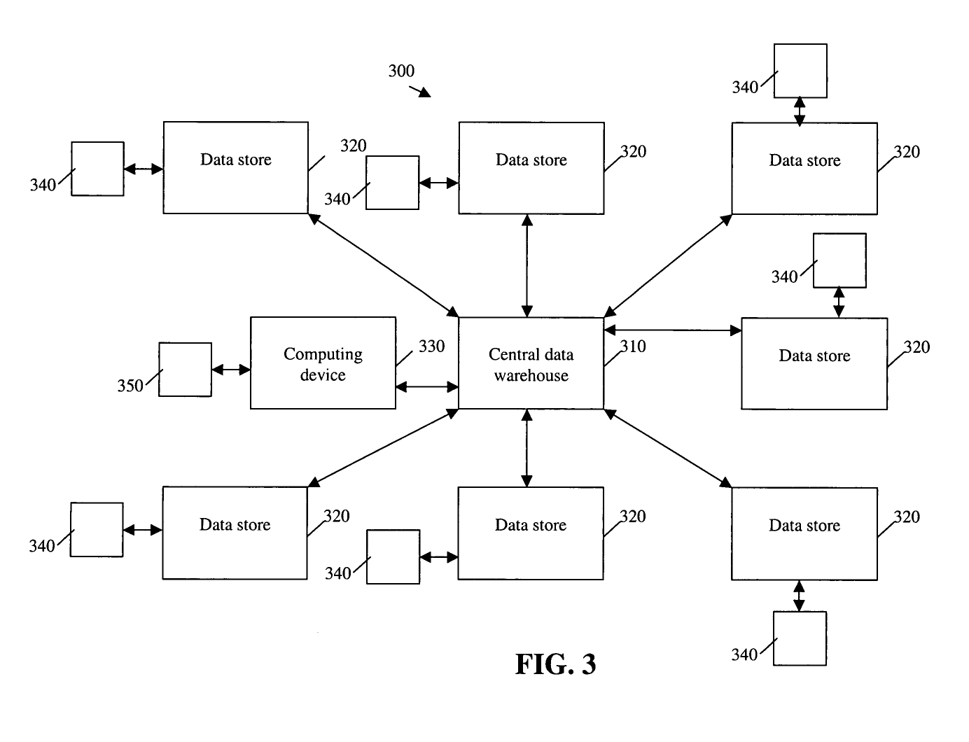

FIG. 3 illustrates a schematic diagram of genetic and/or clinical data aggregation system 300 in accordance with an embodiment of the presently described technology. System 300 includes a central data warehouse 310, a plurality of data stores 320 and a computing device 330. While seven data stores 320 are illustrated in FIG. 3, any number of data stores 320 can be included in system 300. For example, as few as one data store 320 can be included, or many more than seven data stores 320 can be included in system 300.

In an embodiment of the presently described technology, warehouse 310 is similar to the data warehouse system 104 of FIG. 1. In addition, in an embodiment of the presently described technology, one or more data stores 320 are similar to PCP systems 108 of FIG. 1.

Warehouse 310 and each of data stores 320 comprise a storage medium 340 for electronic data. For example, warehouse 310 and data stores 320 can each comprise one or more computer hard drives, server computers, or other electronic storage medium. In an embodiment of the presently described technology, warehouse 310 can be implemented using a server operating in response to a computer program stored in a storage medium accessible by the server. Warehouse 310 can operate as a network server (often referred to as a web server) to communicate with one or more data stores 320.

Computing device 330 includes any electronic device capable of carrying out one or more sets of instructions. For example, computing device 330 can include a desktop or laptop personal computer (“PC”) or a mobile computing device capable of running one or more software applications. Computing device 330 is capable of communicating with warehouse 310 through a wired or wireless connection. For example, computing device 330 can be connected to warehouse 310 through one or more networks such as a LAN, a WAN, an intranet, or a global network (for example, Internet). Computing device 330 can be coupled to warehouse 310 through multiple networks (for example, intranet and Internet).

Computing device 330 includes an input device and an output device (not shown). For example, computing device 330 can include a mouse, stylus, microphone and/or keyboard as an input device. Computing device 330 can include a computer monitor, liquid crystal display (“LCD”) screen, printer and/or speaker as an output device.

Computing device 330 also includes, or is in communication with, a computer-readable memory 350. Computer-readable memory 350 can be similar or the same as storage medium 340. For example, computing device 330 can include a computer hard drive, a compact disc (“CD”) drive, a USB thumb drive, or any other type of memory capable of storing one or more computer software applications. The memory can be included in computing device 330 or physically remote from computing device 330. For example, the memory can be accessible by computing device 330 through a wired or wireless network connection.

The memory 350 accessible to computing device 330 includes a set of instructions for a computer (described in more detail below). The set of instructions includes one or more routines capable of being run or performed by computing device 330. The set of instructions can be embodied in one or more software applications or in computer code.

Data stores 320 are configured to store clinical and/or genetic data from a plurality of patients in a plurality of medical trials or experiments. For example, a portion or entirety of each data store 320 can be dedicated to the storage of clinical and/or genetic data from a particular medical trial at a given hospital or PCP or group of hospitals or PCPs.

In an embodiment of the presently described technology, warehouse 310 handles sending and receiving information to and from one or more data stores 320. In an embodiment, warehouse 310 can also include a firewall to prevent unauthorized access to the data stored at warehouse 310 and enforce any limitations on authorized access. For instance, an administrator may have access to the entire system and have authority to modify portions of the system and a PCP staff member may only have access to view a subset of the data stored at warehouse 310 for particular patients.

Warehouse 310 can also operate as an application server. Warehouse 310 can execute one or more application programs to provide access to the data stored at warehouse 310, as well as application programs to import patient data into a staging area and then into warehouse 310. In addition, warehouse 310 can also execute one or more applications to create patient cohort reports and to send the patient cohort reports to one or more data stores 320. Processing may be shared by warehouse 310 and one or more data stores 320 by providing an application (for example, java applet) to warehouse 310. In another embodiment, warehouse 310 can include a stand-alone software application for performing a portion of the processing described herein. It is understood that separate servers may be used to implement the network server functions and the application server functions. Alternatively, the network server, firewall and the application server can be implemented by a single server executing computer programs to perform the requisite functions.

Warehouse 310 and each of data stores 320 communicate electronically over one or more wired or wireless links. For example, warehouse 310 and one or more data stores 320 can communicate data over a secured or unsecured network connection. The network connection can be one or more networks such as a LAN, a WAN, an intranet, or a global network (for example, Internet). One or more data stores 320 can be coupled to the warehouse 310 through multiple networks (for example, intranet and Internet) so that not all data stores 320 are required to be coupled to the warehouse 310 through the same network.

In an embodiment of the presently described technology, one or more data stores 320 are remote from warehouse 310. In other words, one or more data stores 320 are in a physically and/or geographically separate location from warehouse 310.

The clinical data stored at data stores 320 includes phenotypic expressions of a genetic trait. In an embodiment, the phenotypic expressions are codified according to a coding scheme used by the PCP that stores clinical data at one or more particular data store(s) 320. For example, the clinical data can be stored in an EMR for one or more patients. The EMRs can include any codes or terms used to describe one or more diseases, conditions, medical events and/or medical factors related to one or more patients. The EMRs can store data such as chronic conditions or diseases (for example, diabetes, heart disease, AIDS, cancer, cataracts), allergies (for example, allergies to pharmaceuticals or environmental factors such as smoke, dust, or animals), past adverse reactions to medical therapeutics and/or environmental factors, and/or other general medical problems for each of a plurality of patients seeking medical treatment at a particular PCP and/or participating in a particular medical trial/experiment.

The genetic data stored at data stores 320 (also referred to as genotypic data) includes any structured information representative of genetic information. For example, the genetic data can include data representative of one or more SNPs for one or more patients. In another example, the genetic data can include data representative of a combination of SNPs for one or more patients. In an embodiment, the genetic data for one or more patients is stored in an EMR similar to, or the same EMR as, the clinical data for the same patients.

As described above, one problem with existing EMR systems is that different medical trials, hospitals, clinics and PCPs may employ different syntax or terms to record medical data, including clinical and genetic data. For example, a plurality of data stores 320 may each store genetic and/or clinical data using different terminology or syntax than other data stores 320. Therefore, in operation, the presently described technology normalizes clinical and/or genetic data so that the data (and correlations among the various data) can be more easily and accurately analyzed.

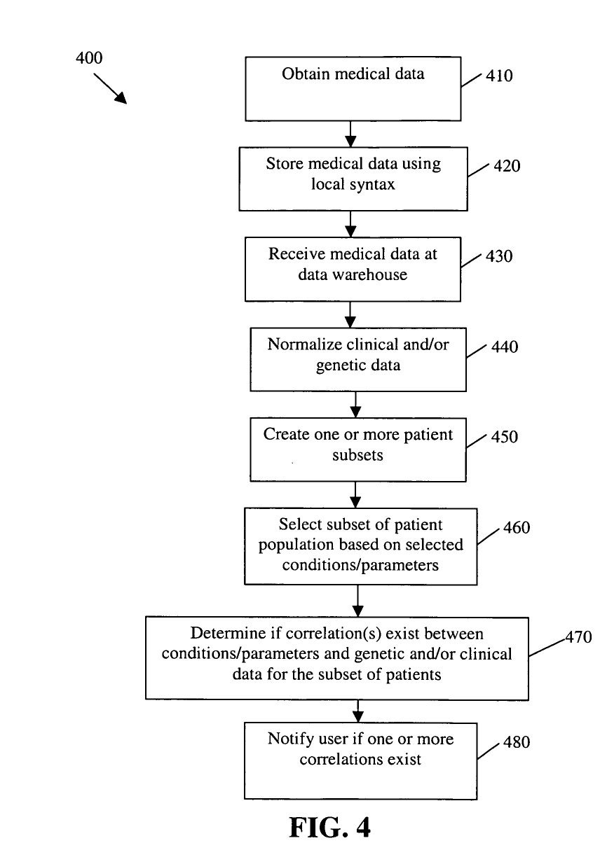

FIG. 4 illustrates a flowchart for a method 400 for evaluating one or more correlations between genetic and clinical data in accordance with an embodiment of the presently described technology. While an embodiment of the presently described technology is described and illustrated by FIG. 4, not all embodiments of the technology are limited to the exact steps described and illustrated in FIG. 4. For example, one or more steps may be added, removed, combined or rearranged in method 400 without departing from the scope of the presently described invention.

First, at step 410, medical data is obtained at a hospital, clinic or other PCP. The medical data can include clinical data and/or genetic data. For example, the medical data can include clinical data such as medical test results, a condition, disease or other medical problem, an allergy, an environmental factor (such as the fact that a patient lives in a household with one or more smokers, lives near power lines, etc.), and/or a codified phenotypic expression of a trait (which can include any of the previously listed clinical data).

Next, at step 420, the medical data is stored in one or more EMRs at a data store 320 or stores 320 used by the PCP that obtained the medical data. In an embodiment of the presently described technology, both clinical and genetic data for patients are stored together in EMRs at data stores 320. In another embodiment, the clinical data is stored separately from genetic data in data stores 320. For example, clinical data for a particular patient can be stored in one EMR at a particular data store 320 and genetic data for the same patient can be stored in a different EMR at the same or different data store 320.

At step 420, the medical data is stored at a plurality of data stores 320 using different syntax or terminology. As described above, this syntax or terminology is likely to differ from the syntax/terminology used by a different PCP to record medical data. For example, different PCPs may refer to the same clinical data relating to diabetes as “diabetic,” “diabetes,” “type I diabetes,” “type 1 diabetes,” or “juvenile diabetes.” In addition, different PCPs may use common terminology such as ICD-9 (International Classification of Diseases, Ninth Revision) codes, ICD-10 codes or CPT (Current Procedure Terminology) codes to record medical data. In another embodiment, a terminology common to a user or group of users of the presently described technology can be used. For example, a particular doctor, group of physicians and/or hospital may have his, her or its own preferred vocabulary to be used. While common terminologies are used as examples here, various embodiments of the presently described technology include using proprietary codes, coding schema, syntax or terminology.

Next at step 430, medical data is received at warehouse 310. In an embodiment of the presently described technology, the medical data is “pushed” by one or more data stores 320 to warehouse 310. For example, the medical data can be communicated from a data store 320 to warehouse 310 without receiving a query or request at data store 320 from warehouse 310. The medical data can be pushed to warehouse 310 on a periodic basis, whenever the data is obtained, or in response to a user request, for example.

In another embodiment, the medical data is “pulled” from one or more data stores 320 to warehouse 310. For example, the medical data can be communicated from a data store 320 to warehouse 310 in response to warehouse 310 communicates a query or request for data to data store 320. Warehouse 310 can communicate the request to data store 320 on a periodic basis or in response to a user request, for example.

Next at step 430, a part or entirety of medical data communicated to warehouse 310 is normalized after it is received at warehouse 310. For example, all or a part of the clinical data and/or genetic data stored at a given data store 320 can be normalized. By “normalizing” it is meant that the various terms and syntax used by various PCPs in recording the medical data are changed or mapped to a common, controlled medical vocabulary used for all medical data.

In another embodiment, normalizing the data can include changing or mapping the terms in the medical data to a vocabulary used by a subset of all users of the presently described technology. For example, instead of using the same common vocabulary for all hospitals or clinics, one or more hospitals, clinics or other subset of users can use their own common vocabulary. In such an embodiment, the vocabulary common only to the subset can differ from the common, controlled medical vocabulary used by one or more other subsets of users.

The medical data can be normalized by mapping terms and syntax used to describe clinical and/or genetic data contained in an EMR to a common, controlled vocabulary. That is, each of several terms that can be considered synonyms and/or describe the same or similar phenotypic expression of a trait, medical condition, disease, or problem are mapped to a single code or term in a controlled vocabulary. For example, the term “juvenile diabetes” can appear in one EMR communicated to warehouse 310 and the term “type 1 diabetic” can appear in another EMR communicated to warehouse 310. These terms can then be mapped, or associated with, a term common to all synonyms for “juvenile diabetes” and “type 1 diabetic” in the respective EMRs. Such a common term can be “type I diabetes,” for example. The mapping of terms can also be performed for any term or codes used to describe genetic data in an EMR.

The common terms can be provided in a list or table stored at warehouse 310. This list or table can also include all synonyms for the common term. Then, when clinical and/or genetic data is communicated in an EMR to warehouse 310, the term(s) used to describe the clinical and/or genetic data can be obtained from the EMR and compared to the synonyms included in the list or table of common terms. If a match is found for the term(s) used to describe the clinical and/or genetic data in the list or table, the common term for all synonyms associated with the clinical and/or genetic data is then mapped to the term(s) used to describe the clinical and/or genetic data. For example, a term used to describe a phenotypic expression of a trait communicated as clinical data in an EMR can be mapped to a common term representative of a group of synonyms for the phenotypic expression of the trait.

In another embodiment of the presently described technology, medical data can be normalized by classifying terms and syntax used to describe clinical and/or genetic data contained in an EMR with an arbitrary term, such as a numeric or alphanumeric code or classification. For example, terms in the medical data can be normalized by codifying them with an ICD code. That is, each of several terms that can be considered synonyms and/or describe the same or similar medical problem are codified by assigning the terms to a single code or arbitrary term. For example, the term “juvenile diabetes” can appear in one EMR communicated to warehouse 310 and the term “type 1 diabetic” can appear in another EMR communicated to warehouse 310. These terms can then be codified with a numeric code that is common to a group of synonyms for “juvenile diabetes.”

The codes or arbitrary terms can be provided in a list or table stored at warehouse 310. This list or table can also include a group of synonyms for the code or arbitrary terms. Then, when a phenotypic expression of a trait is communicated in an EMR to warehouse 310, for example, the term used to describe the phenotypic expression of the trait can be obtained from the EMR and compared to the synonyms included in the list or table of codes/arbitrary terms. If a match is found, the EMR is then codified with the code common term to a group of synonyms associated with the expression of the trait.

Next, at step 450, one or more subsets of patients is created. The subsets can be created to divide up the entire population of codified clinical or medical data into one or more groups (that is, subsets) of patients with one or more phenotypic expressions of a trait, medical conditions, diseases, medical problems or environmental conditions in common.

These subsets can be created by a user first selecting or inputting at least one clinical condition. The user can input or select the condition(s) into device 330. The clinical conditions input by the user include one or more parameters related to the clinical and/or genetic data in one or more of the EMRs stored at warehouse 310. The clinical conditions input by the user can include any medical or genetic data, problem, condition or disease. For example, the clinical conditions can include diseases, chronic ailments, disabilities, adverse reactions to medical therapeutics, allergies, environmental factors, and other medical problems. Environmental factors can include any information relevant to the environment in which a patient lives or works. For example, the fact that a patient is a smoker, lives in a home with smokers, works in a smoke-filled environment, is a descendant of someone who died from bronchogenic carcinoma, lives near power lines, and has relatives with one or more other clinical conditions are each examples of environmental factors. In addition, a patient's diet and/or pattern of exercise are other examples of environmental factors.

In another example, at step 450 a subset of patients can be created that includes all patients that take a particular prescription drug, such as Lipitor. Another subset of patients can be created that includes all patients that were checked for a particular medical problem using a particular laboratory or clinical test. For example, a subset can include all patients that have been checked for muscle breakdown using a test that measures muscle enzymes.

More than one clinical condition can be used to create or generate a subset. In continuing with the above example, a subset can be created that includes all patients that take a particular prescription drug and have a particular medical problem or laboratory test result. For example, a subset can include all patients that take Lipitor (at or above a certain dose, for example) and that have muscle breakdown (measured using a laboratory test for muscle enzymes, for example).

The clinical conditions can also include genetic data. For example, the clinical conditions can include one or more SNPs or one or more combinations of SNPs.

The user can input the clinical conditions using computing device 330. For example, the user can use an input device to type or select one or more clinical conditions displayed on an output device into a computer-generated list. The clinical conditions are used to generate a population, or group, of patients with one or more similar or identical clinical conditions, as described above. That is, the list of clinical conditions is used by computing device 330 to search through all or a subset of the EMRs (or to all or a subset of the data contained in one or more EMRs) to find the same or similar clinical conditions in the EMR(s). If a match for one or more of the clinical conditions input by the user in one or more EMRs, those EMRs and the patients associated with the EMRs are included in a subset of patients to be examined.

As described above, the clinical and/or genetic data included in EMRs stored at warehouse 310 is normalized at step 440 so that different terms used to describe the same or similar clinical and/or genetic data in various EMRs from various data stores 320 are mapped to a common term or are encoded with the same or similar code. In this way, medical data input by different persons, hospitals, or groups using different terms, syntax or vocabularies can easily be scanned or searched to provide a subset of patients with the same or similar medical or clinical conditions.

In an embodiment of the presently described technology, computing device 330 selects only those EMRs with data that matches each clinical condition included in the list. Therefore, if a list includes five clinical conditions and an EMR includes data that matches four or less of the clinical conditions, then the EMR is not selected. On the other hand, if a list includes five clinical conditions and an EMR includes data that matches all five of the clinical conditions, then the EMR is selected.

In another embodiment of the presently described technology, computing device 330 selects only those EMRs with data that matches a number of clinical conditions included in the list that exceeds a threshold. For example, if a threshold is set at three matches and a list includes five clinical conditions, an EMR must include data that matches at least three of the clinical conditions in the list. If the EMR only includes data that matches two or less conditions in the list, then the EMR is not selected.

In another embodiment of the presently described technology, computing device 330 selects EMRs with data that matches a number of clinical conditions included in the list that meets or exceeds one of a plurality of thresholds. For example, three thresholds can be set at five matches (between EMR data and the list of clinical conditions), three matches and one match. If an EMR includes data that matches enough clinical conditions to meet or exceed one of the thresholds, the EMR is selected and placed into a category associated with the threshold number of matches. In continuing with the above example, an EMR with data that matches two clinical conditions is placed into the category of EMRs with data that matches at least one, but less than three clinical conditions; an EMR with data that matches three clinical conditions is placed into the category of EMRs with data that matches at least three, but less than five clinical conditions; and an EMR with data that matches eight clinical conditions is placed into the category of EMRs with data that matches at least five clinical conditions. By sorting the EMRs according to the number of matches between the EMR data and the list of clinical conditions, a user of the presently described technology can obtain several patient populations to select from based on the number of EMR data and list matches. Again continuing with the above example, if given a set of 100 EMRs and the above thresholds, where 25 EMRs include data matching at least one, but less than three clinical conditions in the list, 5 EMRs include data matching at least three, but less than five clinical conditions in the list, 2 EMRs include data matching at least five clinical conditions, and 68 EMRs that do not include any data that matches any clinical condition, a user can select the group of 25 EMRs for his/her analysis.

In another embodiment of the presently described technology, computing device 330 selects EMRs with data that matches a number of clinical conditions included in the list that meets or exceeds one or more of a plurality of thresholds. For example, three thresholds can be set at five matches (between EMR data and the list of clinical conditions) (referred to as “Category 5”), three matches (referred to as “Category 3”) and one match (referred to as “Category 1”). If an EMR includes data that matches enough clinical conditions to meet or exceed one or more of the thresholds, the EMR is selected and placed into each category associated with the threshold number of matches that the EMR data meets or exceeds. In continuing with the above example, an EMR with data that matches two clinical conditions is placed into Category 1; an EMR with data that matches three clinical conditions is placed into both Category 1 and Category 3; and an EMR with data that matches eight clinical conditions is placed into Category 1, Category 3 and Category 5. By sorting the EMRs according to the number of matches between the EMR data and the list of clinical conditions, a user of the presently described technology can obtain several patient populations to select from based on the number of EMR data and list matches.

In an embodiment of the presently described technology, a user can input a plurality of lists of clinical conditions and obtain a plurality of subsets of EMRs and/or patients that match one or more of the lists (as described above). The user can then use computing device 330 to select which list(s) he or she wants to use in his or her analysis of the data.

In an embodiment of the presently described technology, after a user has input a list of clinical conditions and obtained a subset of EMRs and/or patients that match one or more of the lists, the user can employ the input device of computing device 330 to change one or more clinical conditions in the list and view the corresponding change(s) to the subset of EMRs and/or patients that match the changed list. This change in the subset of EMRs and/or patients can occur in substantially real time. By “substantially real time,” it is meant that the change in the list and/or corresponding change in the subset of EMRs/patients occurs and is presented to the user on an output device in a time period no longer than required for computing device 330, warehouse 310 and/or data stores 320 to select and present the data. That is, no intentional delay is added to the selection of data that matches the changed list. By allowing a user to dynamically change the list and subset of EMRs/patients in this way, a user can quickly change one or more parameters/clinical conditions included in the list to view the impact on the number of EMRs/patients that match the list after the change(s).

Once the one or more subsets of patients has been created at step 450, a user can select one or more of the subsets at step 460. For example, several subsets can be created at step 450 and one subset can be preferred (and selected) over other subsets. One such selected subset can be a subset with the largest number of patients in it, for example. In another example, a subset can be selected because it includes a number of patients above a threshold number of patients. The selection of a subset can be performed manually or automatically. For example, a user can manually select a subset using an input device connected to computing device 330. In another example, a subset can be selected automatically if the number of patients in the subset is at or above a threshold, or has the largest number of patients in it when compared to the other subsets.

Next, at step 470, a determination is made as to whether any correlations exist among the genetic data associated with the patients in the selected subset(s). That is, once a subset of patients is selected, a determination is made as to whether a statistically significant number of the patients are associated with or have EMRs that contain the same or similar data. For example, a determination can be made at step 470 as to whether a statistically significant number of patients include the same SNP, the same plurality of SNPs or the same medical problem.

In an embodiment of the presently described invention, the correlation(s) are determined or calculated between genetic data included in the subset of EMR(s) and one or more of the clinical conditions in the list generated at step 450. That is, a determination is made as to whether a sufficient number of patients are associated with EMRs that include the same or similar genetic data. For example, if a number of patients exceeding a threshold have EMRs with the same SNP(s) or group(s) of SNPs, then a correlation is determined to exist. Such a determination is useful for finding correlations between medical problems, diseases, environmental factors, allergies, for example, and certain genetic data, such as SNPs or groups of SNPs.

In another embodiment of the presently described technology, the clinical condition(s) selected by a user to create a list of EMRs at step 450 is genetic data. For example, the user selects one or more SNPs or groups of SNPs as clinical conditions. Then, at step 470, a determination is made as to whether a sufficient number of patients are associated with EMRs that include the same or similar clinical data. For example, if a number of patients exceeding a threshold have EMRs with the same medical problem, allergy, environmental factor, or disease, then a correlation is determined to exist. Such a determination is useful for finding “mirror-image” correlations to those described above. Specifically, such a determination is useful for finding correlations between genetic data, such as SNPs or groups of SNPs, and certain medical problems, such as diseases and allergies, for example.

In an embodiment of the presently described technology, a correlation between clinical conditions and clinical and/or genetic data is only found at step 470 if a number of patients or EMRs exceeds a threshold. For example, if a threshold is set at 70 and over 70 patients have or EMRs include the same or similar genetic and/or clinical data (as described above), then a correlation exists.

In another embodiment of the presently described technology, a correlation between clinical conditions and clinical and/or genetic data is only found at step 470 if a percentage of patients or EMRs selected at step 460 exceeds a threshold. For example, if a threshold is set at 70 percent and over 70 percent of the patients or EMRs selected at step 460 have or EMRs include the same or similar genetic and/or clinical data (as described above), then a correlation exists.

Next, at step 480, if one or more correlations is determined to exist, the user is provided with a notification by computing device 330 once a correlation is found to exist. The notification can be a visual display or audible sound on an output device on computing device 330, for example.

In another embodiment of the presently described technology, one or more steps in method 400 is eliminated or performed in an order different from that described above and illustrated in FIG. 4. For example, step 460 can be omitted. In such an example, method 400 proceeds from the creation of one or more patient subsets (at step 450) to the determination of whether any correlations exist between the genetic data of the patients in the subset and their associated medical problems/conditions (at step 470), for example.

The presently described invention provides, among other things, an automated method to narrow a large population of patients or EMRs to a subset determined according to a list of clinical conditions input by a user, where the subset of patients/EMRs can then be analyzed to determine if any genetic data and/or clinical data is common to the subset of patients/EMRs. Such a method provides a faster, more efficient ability to perform analysis on a large amount of genetic and clinical data. In addition, as data obtained from a plurality of clinical trials, PCPs, hospitals and clinics (for example) is normalized before analysis, correlations among patients/EMRs and clinical and/or genetic data can be determined even if many or all of the sources of the data employ different syntax to record the data.

In another embodiment of the presently described technology, step 440 occurs before step 430. That is, the normalization of the data stored at the various data stores 320 occurs before the data is communicated to warehouse 310. The normalization can be performed by a computing device similar or identical to computing device 330 that is connected to a data store 320. In this manner, the data included in an EMR stored at a data store 320 is normalized before it is received at warehouse 310 so that no additional normalization is required.

As described above, in an embodiment of the presently described technology, a computer-readable memory is accessible to computing device 330 and includes a set of instructions for a computer. The set of instructions includes one or more routines capable of being run or performed by computing device 330. The set of instructions can be embodied in one or more software applications or in computer code.

The set of instructions can include a data normalization routine configured to normalize one or more of the genotypic data and clinical data associated with each patient in a population of patients. As described above with respect to step 440 of method 400, clinical data and/or genetic (or genotypic) data can be stored on EMRs at various data stores 320. Once a plurality of these EMRs (that can each include different terms or syntax to describe the clinical and/or genetic data) are received at warehouse 310, the normalization routine can cause computing device 330 to normalize the data. That is, the normalization routine can receive the data and normalize it. As described above, the normalization of the data can occur, for example, by mapping terms used to describe the same or similar medical conditions or genetic information to a single common term or by codifying synonyms of the same or similar medical conditions or genetic information to an alphanumeric code.

In another embodiment of the presently described technology, the data normalization routine can be included in a second set of instructions stored on a computer-readable medium accessible by one or more computer devices in communication with one or more data stores 320. As described above, the normalization of data can occur before the data is communicated from data store(s) 320 to warehouse 310. In such an embodiment, the normalization routine can operate on, or cause a computing device in communication with a data store 320 to normalize the data before the data in the EMR is communicated to warehouse 310, for example.

The set of instructions can also include a patient selection routine configured to select a subset of patients from said population based on one or more clinical conditions input by a user. As described above with respect to step 450 of method 400, a subset of EMRs can be selected from a group of EMRs stored at warehouse 310 based on a plurality of clinical conditions input by a user, for example. The patient selection routine can operate on, or cause computing device 330 to select the subset of EMRs from the group of EMRs at warehouse 310.

The set of instructions can also include a correlation routine configured to determine one or more correlations between at least one of the clinical conditions and one or more of the genetic and clinical data. As described above with respect to step 470 of method 400, one or more correlations or relationships between one or more clinical conditions input by a user (such as a medical problem or SNP/group of SNPs, for example) and genetic and/or clinical data included in the EMRs selected by the patient selection routine at step 460 can be calculated. The correlation routine can operate on, or cause computing device 330 to determine or calculate the correlation(s), if any, existing between the clinical conditions and the data, as described above.

In an embodiment of the presently described technology, the set of instructions can include a notification routine configured to notify a user when one or more of correlations calculated or determined by the correlation routine exceed one or more thresholds. As described above with respect to step 480 of method 400, once a correlation is found to exist by the correlation routine, a notification is communicated to a user. For example, the notification routine can operate on, or cause computing device 330 to provide a visual display on a display device or provide an audio notification on a speaker.

In an embodiment of the presently described technology, the set of instructions can include an input routine configured to alter one or more thresholds that an amount of match between one or more clinical conditions selected by a user and genetic and/or clinical data in the subset of EMRs is compared against. As described above, a user can employ an input device of computing device 330 to change one or more clinical conditions in the list of clinical conditions and view any corresponding change(s) to the subset of EMRs and/or patients that match the changed list. For example, the input routine can receive input from a user in the form of the selection or de-selection (that is, removing one or more clinical conditions from a list of clinical conditions previously selected by the user) of one or more clinical conditions. The input routine can then operates on, or causes computing device 330 to alter the list of clinical conditions and, consequently, causes the patient selection routine to change the EMRs included in the subset of EMRs selected by the patient selection routine, for example.

The technical effect of the set of instructions described above is, among other things, to provide an automated method to narrow a large population of patients or EMRs to a subset determined according to a list of clinical conditions input by a user, where the subset of patients/EMRs can then be analyzed to determine if any genetic data and/or clinical data is common to the subset of patients/EMRs. The set of instructions can then provides a faster, more efficient ability to perform analysis on a large amount of genetic and clinical data. In addition, as data obtained from a plurality of clinical trials, PCPs, hospitals and clinics (for example) is normalized before analysis, correlations among patients/EMRs and clinical and/or genetic data can be determined even if many or all of the sources of the data employ different syntax to record the data, for example.

While the invention has been described with reference to example embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

In addition, while particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

What is claimed is:

1. A method for evaluating correlations between genetic variations and clinical information, said method including:
normalizing one or more of genotypic data and clinical data associated with each of a plurality of patients in a population of patients;
receiving one or more clinical conditions from a user;
creating a subset of patients from said population based on a comparison of said clinical conditions to said clinical data; and
determining one or more correlations between at least one of said clinical conditions and one or more of said genotypic data and said clinical data for said subset of patients.

2. The method of claim 1, wherein said genotypic data includes one or more single nucleotide polymorphisms (“SNP”).

3. The method of claim 1, wherein said clinical data includes a codified phenotypic expression of a trait.

4. The method of claim 1, further including receiving one or more of said genotypic data and said clinical data from each of a plurality of remote data stores, said remote data stores storing data obtained from different clinical trials.

5. The method of claim 1, wherein said normalizing step includes:
determining one or more synonyms for a term used to describe a phenotypic expression of a trait included in said clinical data; and
mapping said term to a common term from a controlled vocabulary, said common term representative of said term and said synonyms.

6. The method of claim 1, wherein said normalizing step includes:
determining one or synonyms for a term used to describe a phenotypic expression of a trait included in said clinical data; and
encoding said clinical data with a classification of said phenotypic expression of said trait, said classification representative of said phenotypic expression of said term and said synonyms.

7. The method of claim 1, wherein said selecting step includes selecting said patients that are associated with at least one of said genotypic data and said clinical data that matches one or more of said clinical conditions.

8. The method of claim 1, wherein said clinical conditions include one or more of a disease, an adverse reaction to a medical therapeutic, an environmental factor, an allergy and a medical problem.

10. The method of claim 1, wherein said clinical conditions input by said user include one or more single nucleotide polymorphisms (“SNP”).

11. The method of claim 1, wherein said correlations include one or more calculations of an amount of match between at least one of said clinical conditions and one or more of said genotypic data and said clinical data.

12. The method of claim 11, further including notifying a user when one or more of said correlations exceeds a threshold.

13. The method of claim 12, further including altering said threshold after said determining step.

14. A computer-readable storage medium comprising a set of instructions for a computer, said instructions comprising:
a data normalization routine configured to normalize one or more of genotypic data and clinical data associated with each of a plurality of patients in a population of patients;
a patient selection routine configured to create a subset of patients from said population based on one or more clinical conditions input by a user; and
a correlation routine configured to determine one or more correlations between at least one of said clinical conditions and one or more of said genotypic data and said clinical data for said subset of patients.

15. The set of instructions of claim 14, wherein said genotypic data includes one or more single nucleotide polymorphisms (“SNP”).

16. The set of instructions of claim 14, wherein said clinical data includes a codified phenotypic expression of a trait.

17. The set of instructions of claim 14, wherein said data normalization routine is configured to receive one or more of said genotypic data and said clinical data from a remote data store.

18. The set of instructions of claim 14, wherein said data normalization routine is configured to normalize said clinical data by determining one or more synonyms associated with a term used to describe a phenotypic expression of a trait included in said clinical data and mapping said term to a common term from a controlled vocabulary, said common term representative of said term and said synonyms.

19. The set of instructions of claim 14, wherein said data normalization routine is configured to normalize said clinical data by determining one or more synonyms associated with a term used to describe a phenotypic expression of a trait included in said clinical data and encoding said clinical data with a classification, said classification representative of said term and said synonyms.

20. The set of instructions of claim 14, wherein said patient selection routine is configured to select said patients that are associated with at least one of said genotypic data and said clinical data that matches one or more of said clinical conditions.

21. The set of instructions of claim 14, wherein said clinical conditions include one or more of a disease, an adverse reaction to a medical therapeutic, an environmental factor, an allergy and a medical problem.

22. The set of instructions of claim 14, wherein said clinical conditions input by said user include one or more single nucleotide polymorphisms (“SNP”).

23. The set of instructions of claim 14, wherein said correlations include one or more calculations of an amount of match between at least one of said clinical conditions and one or more of said genotypic data and said clinical data.

24. The set of instructions of claim 23, further including a notification routine configured to notify a user when one or more of said correlations exceeds a threshold.

25. The set of instructions of claim 24, further including an input routine configured to alter said threshold based on input from said user.

26. A method for determining correlations between genetic data and medical data, said method including:
receiving genotypic data and clinical data associated with each of a plurality of patients from a plurality of sources, a plurality of said plurality of sources employing different terms to report said genotypic data and said clinical data;
normalizing said genotypic data and/or said clinical data;
selecting one or more patients from said plurality of patients based on one or more parameters; and
determining a correlation between one or more of said parameters and at least one of said genotypic data and said clinical data associated with a plurality of said patients selected from said plurality of patients.

27. The method of claim 26, wherein said plurality of sources includes a plurality of remote data stores storing data obtained from different clinical trials.

28. The method of claim 26, wherein said genotypic data includes one or more single nucleotide polymorphisms (“SNP”).

29. The method of claim 26, wherein said clinical data includes a codified phenotypic expression of a trait.

30. The method of claim 26, wherein said selecting step includes selecting said patients if one or more of said parameters matches one or more of said genotypic data and said clinical data for each of said selected patients.

31. The method of claim 30, wherein said selecting step includes selecting said patients if an amount of match between one or more of said parameters and one or more of said genotypic data and said clinical data for each of said selected patients exceeds a threshold.

32. The method of claim 26, wherein said parameters can be changed dynamically to alter said selected patients.
